(19) United States
(12) Patent Application Publication
(10) Pub. No.: US 2026/0134252 A1
(43) Pub. Date: May 14, 2026

(54) TUNING DEVICE, TUNING METHOD, AND TUNING PROGRAM

(71) Applicant: NTT, Inc, Tokyo (JP)

(72) Inventor: Masanori YAMADA, Tokyo (JP)

(73) Assignee: NTT, Inc, Tokyo (JP)

(21) Appl. No.: 19/118,803

(22) PCT Filed: Nov. 16, 2022
(86) PCT No.: PCT/JP2022/042629

§ 371 Date: Apr. 7, 2025

(51) Int. Cl. G06N 3/045; G06F 40/40

(52) U.S. Cl. CPC G06N 3/045; G06F 40/40

(57) ABSTRACT

An information processing device includes a calculation part, a correction part, and an updating part. The calculation part uses a model using BERT to calculate an output for each of a plurality of input vectors. The correction part corrects a vector so that the norm of the vector input to a normalization layer included in the model is constant. The updating part updates the model so that the output is optimized.

### TECHNICAL FIELD

The present invention relates to an adjustment device, an adjustment method, and an adjustment program.

### BACKGROUND ART

In recent years, natural language processing has been applied in various fields, including chatbots. Bidirectional Encoder Representations from Transformers (BERTs) are known as a machine training model for natural language processing. According to BERT, tasks such as natural language translation can be performed with a high degree of accuracy.

BERT is a huge model with over 100 million parameters. For this reason, in order to train BERT, in reality, a huge data set is needed. On the other hand, it may be possible to train BERT on a small data set through processes called pre-training and fine-tuning.

In pre-training, training of parameters in which a huge data set is used is performed. Also, in fine-tuning, using, as initial values, parameters which have been pre-trained through pre-training, training in which a small data set which is specific to a task to be solved is used is performed.

For example, in business situations, if a user has a pre-trained BERT model, it is possible to use BERT just by performing fine-turning in accordance with a task.

### CITATION LIST

### Non Patent Literature

[NPL 1] ON THE STABILITY OF FINE-TUNING BERT: MISCONCEPTIONS, EXPLANATIONS, AND STRONG BASELINES, [online], [retrieved Nov. 2, 2022], Internet (https://arxiv.org/pdf/2006.04884.pdf)
[NPL 2] On Layer Normalization in the Transformer Architecture, [online], [Retrieved Nov. 2, 2022], Internet (https://arxiv.org/pdf/2002.04745.pdf)
[NPL 3] Sentence-BERT: Sentence Embeddings using Siamese BERT-Networks, [online], [Retrieved Nov. 2, 2022], Internet (https://arxiv.org/pdf/1908.10084.pdf)

### SUMMARY OF INVENTION

### Technical Problem

Here, the techniques in the related art have a problem in that the accuracy of the model cannot be easily improved through fine-tuning.

For example, NPL 1 describes that, when fine-tuning is performed using a pre-trained BERT, the training becomes unstable (for example, accuracy changes significantly depending on the difference in the random number seed).

In order to improve the accuracy of a model through fine-tuning, it is necessary to search for hyperparameters which are appropriate for the data. Furthermore, since the accuracy of fine-tuning depends heavily on the random number seed, it is necessary to try a plurality of seeds for each of the hyperparameters.

Trying a plurality of seeds for each of the hyperparameters is not easy because it requires large training costs (for example, time). On the other hand, if hyperparameters are not explored, it is difficult to improve the accuracy of the model.

### Solution to Problem

In order to solve the above problems and achieve the object, an adjustment device includes: a calculation part which calculates an output for each of a plurality of input vectors using a model using BERT; a correction part which corrects a vector input to a normalization layer included in the model so that a norm of the vector is constant; and an updating part which updates the model so that the output is optimized.

### Advantageous Effects of Invention

According to the present invention, it is possible to easily improve the accuracy of a model through fine-tuning.

### BRIEF DESCRIPTION OF DRAWINGS

FIG. 1 is a diagram showing an example of a configuration of an adjustment device according to a first embodiment.

FIG. 2 is a schematic diagram showing a structure of BERT.

FIG. 3 is a schematic diagram showing a structure of Transformer.

FIG. 4 shows results of a preliminary experiment.

FIG. 5 shows results of a preliminary experiment.

FIG. 6 shows results of a preliminary experiment.

FIG. 7 is a diagram showing an effect of the first embodiment.

FIG. 8 is a diagram showing an effect of the first embodiment.

FIG. 9 is a diagram showing an effect of the first embodiment.

FIG. 10 is a flowchart for describing a flow of a fine-tuning process.

FIG. 11 is a flowchart for describing a processing flow through Transformer.

FIG. 12 is a diagram for explaining an example of application of the first embodiment to a business chat.

FIG. 13 is a diagram showing an example of a computer which executes an adjustment program.

### DESCRIPTION OF EMBODIMENTS

Embodiments of an adjustment device, an adjustment method, and an adjustment program according to the present application will be described in detail below with reference to the drawings. Note that the present invention is not limited to the embodiments which will be described below.

### Configuration of First Embodiment

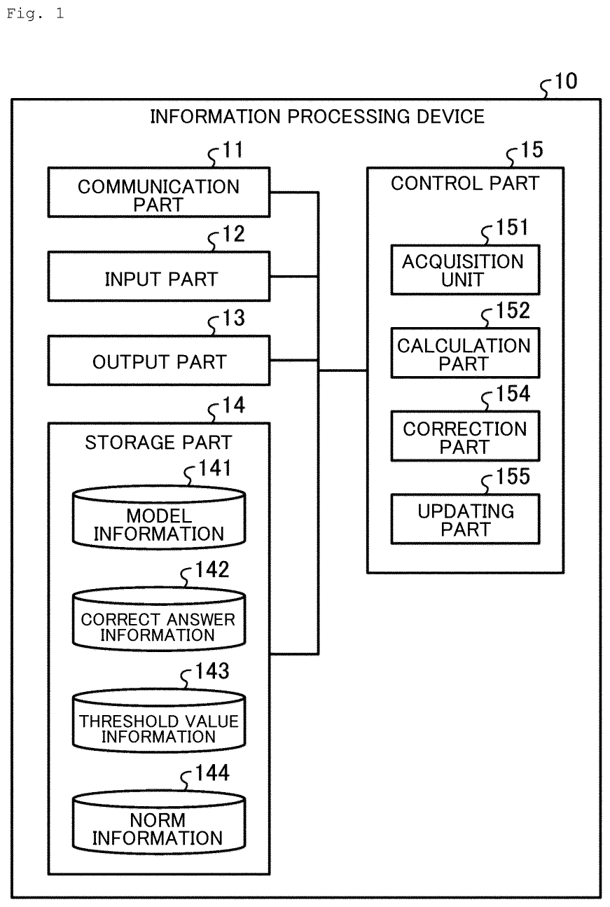

First, a configuration of an adjustment device according to a first embodiment will be described with reference to FIG. 1. FIG. 1 is a diagram showing an example of the configuration of an adjustment device according to the first embodiment. An information processing device 10 shown in FIG. 1 is an example of the adjustment device. For example, the information processing device 10 is a personal computer, a server device, a smartphone, a tablet terminal, or the like.

The information processing device 10 can perform fine-tuning of BERT. Furthermore, the information processing device 10 can perform tasks relating to natural language processing, such as text reading, speech recognition, and translation using the fine-tuned BERT.

Note that, in the embodiment, it is assumed that the information processing device 10 has already acquired information such as parameters capable of constructing a pre-trained BERT. Here, the information processing device 10 may perform pre-training on BERT.

The information processing device 10 receives, as an input, training data for performing fine-tuning. Furthermore, the information processing device 10 outputs information (for example, parameters) relating to the fine-tuned BERT.

Furthermore, the information processing device 10 may receive input data for a task using BERT and output a result of performing the task using the fine-tuned BERT.

As shown in FIG. 1, the information processing device 10 includes a communication part 11, an input part 12, an output part 13, a storage part 14, and a control part 15.

The communication part 11 performs data communication with other devices via a network. For example, the communication part 11 is a network interface card (NIC).

The input part 12 receives data input from a user. The input part 12 is, for example, an input device such as a mouse and a keyboard. Furthermore, the input part 12 may be an interface through which the information processing device 10 is connected to an input device.

The output part 13 outputs data by displaying it on a screen or the like. The output part 13 is, for example, an output device such as a display and a speaker. Moreover, the output part 13 may be an interface through which the information processing device 10 is connected to an output device.

The storage part 14 is a storage device such as a hard disk drive (HDD), a solid state drive (SSD), or an optical disc. The storage part 14 may be a semiconductor memory in which data can be rewritten, such as a random access memory (RAM), a flash memory, or a non-volatile static random access memory (NVSRAM). The storage part 14 stores an operating system (OS) and various programs executed using the information processing device 10.

The storage part 14 stores model information 141, correct answer information 142, threshold value information 143, and norm information 144.

The model information 141 is information relating to the model. For example, the model information 141 includes parameters or the like for constructing a pre-trained BERT. Also, for example, the parameters are weights and biases in a neural network included in BERT.

The correct answer information 142 is information for performing fine-tuning according to the task. The correct answer information 142 is a combination of a text in a natural language and correct answer information corresponding to the text.

The correct answer information 142 may be a combination of a text representing the user's speech and the chatbot's response to the speech. Moreover, the correct answer information 142 may be a combination of text in a first language (for example, Japanese) and text in a second language (for example, English) translated from the text.

The threshold value information 143 is a threshold value used at the time of performing a task. The use of threshold values in tasks will be described later.

The norm information 144 is the norm recorded during fine-tuning. In fine-tuning of BERT, a sequence of vectors is input to the model. At this time, the calculation process is repeatedly performed. For example, the calculation process is repeatedly performed for the number of vectors included in a plurality of sequences. The norm information 144 is a norm shared between each of the repeatedly performed calculation processes. A specific usage method of the norm information 144 will be described later.

The control part 15 controls the entire information processing device 10. The control part 15 is, for example, an electronic circuit such as a central processing unit (CPU), a micro processing unit (MPU), or a graphics processing unit (GPU) or an integrated circuit such as an application specific integrated circuit (ASIC) or a field programmable gate array (FPGA). Furthermore, the control part 15 has an internal memory for storing programs which define various processing procedures and control data, and performs each process using the internal memory.

The control part 15 functions as various processing parts by operating various programs. For example, the control part 15 includes an acquisition unit 151, a calculation part 152, a correction part 154, and an updating part 155.

Here, the structure of the BERT in the embodiment and each processing part of the control part 15 will be described.

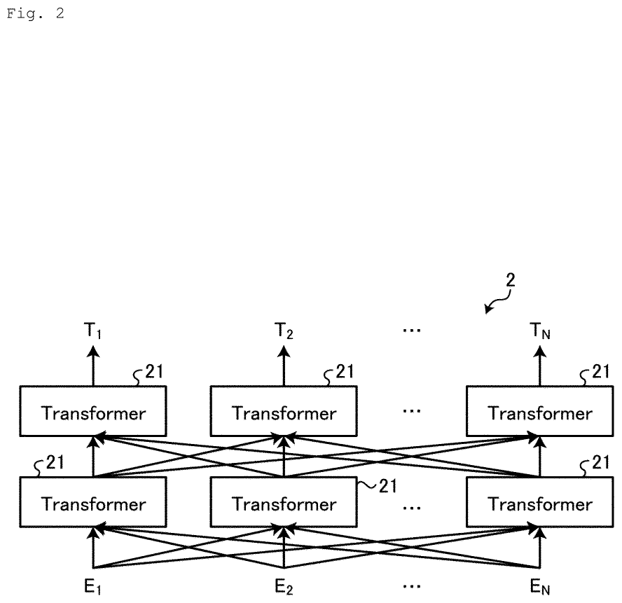

FIG. 2 is a schematic diagram showing a structure of BERT. As shown in FIG. 2, Model 2 which is BERT, has a plurality of Transformers 21. Furthermore, a sequence of vectors (E₁, E₂, . . . , E_{N}) is input to model 2. Moreover, Model 2 outputs a sequence of vectors (T₁, T₂, . . . , T_{N}). For example, each element of the vector sequences (E₁, E₂, . . . , E_{N}) and (T₁, T₂, . . . , T_{N}) represents a string of characters (for example, a word) which constitutes a sentence.

Model 2 in FIG. 2 has a two-layer structure, and in reality, one Transformer 21 is required for each layer, for a total of two Transformers 21. For example, the model information 141 includes parameters of Transformer 21 in the first layer and parameters of Transformer 21 in the second layer. Also, vectors E₁, E₂, . . . , E_{N} are input in sequence to Transformer 21 in the first layer.

In addition, in BERT, N outputs of the Transformer in the previous layer are input to each Transformer 21 from both directions (both from a left side to a right side and from a right side to a left side in FIG. 2). For example, Transformer 21 in the second layer receives N outputs from Transformer 21 in the first layer which correspond to vectors E₁, E₂, . . . , E_{N}.

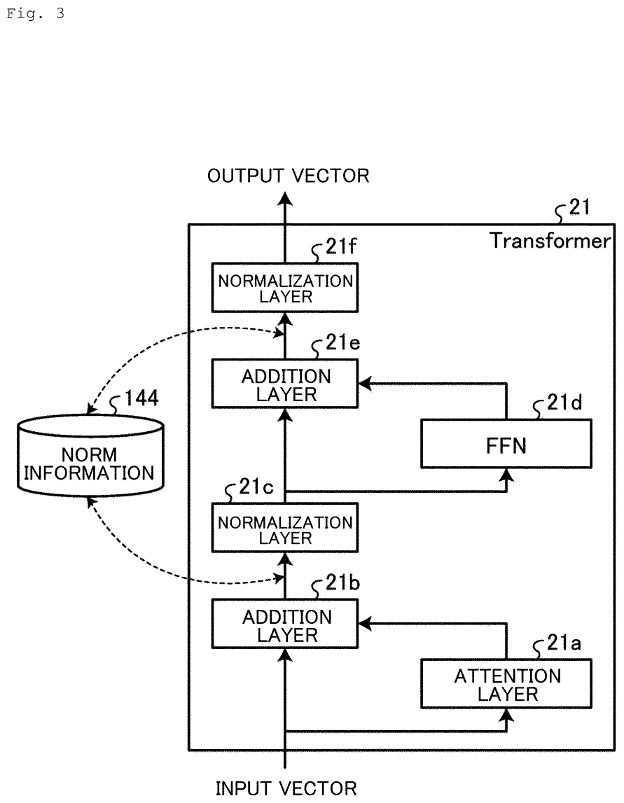

FIG. 3 is a schematic diagram showing a structure of Transformer. As shown in FIG. 3, Transformer 21 includes an attention layer 21a, an addition layer 21b, a normalization layer 21c, a feed-forward neural network (FFN) 21d, an addition layer 21e, and a normalization layer 21f.

The attention layer 21a is a neural network which functions as an attention mechanism. The addition layer 21b and the addition layer 21e add up a plurality of input vectors. An FFN 21d is a neural network in which each of the parts outputs in only one direction (the output side).

A normalization layer 21c and a normalization layer 21f perform layer normalization Layer Norm. Furthermore, in the embodiment, norm correction may be performed on vectors input to the normalization layer 21f.

Note that the configurations of the BERT and the Transformer in this embodiment are not limited to those described here. The configuration of the BERT may be the configuration described in NPL 1 or a configuration similar to that described in NPL 1. Furthermore, the configuration of the BERT may be that described in Reference 1.

Reference 1: BERT: Pre-training of Deep Bidirectional Transformers for Language Understanding (https://arxiv.org/pdf/1810.04805.pdf)

Furthermore, the configuration of the Transformer may be the configuration described in NPL 2 (Post-LN Transformer layer or Pre-LN Transformer layer) or a configuration similar to that described in NPL 2.

Particularly, the normalization layer 21c and the normalization layer 21f in FIG. 3 normalize the vectors using a method similar to the Layer Norm described in NPL 2. Here, this embodiment has a method which is different from the method described in NPL 2 in that the norms of the vectors input to normalization layer 21c and normalization layer 21f may be corrected.

Here, as described in NPL 1, a preliminary experiment conducted by the inventor to confirm that the fine-tuning of the BERT in the related art is unstable will be described.

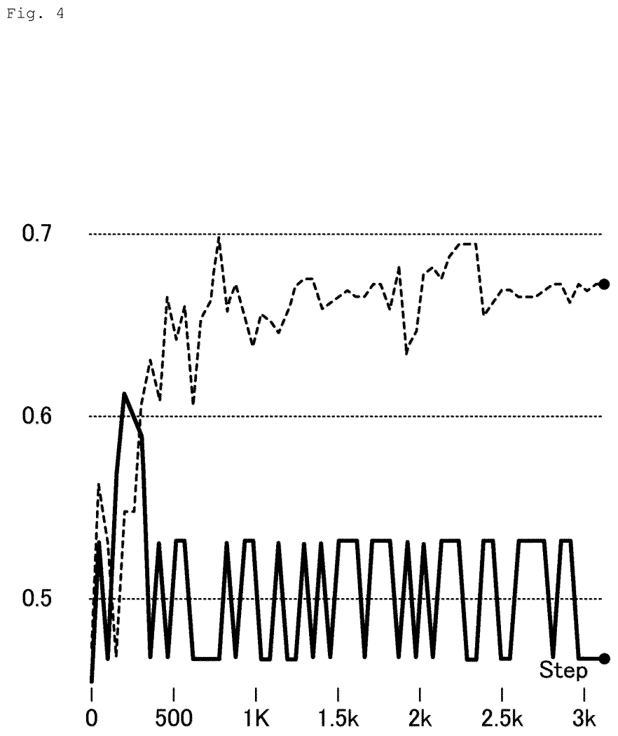

In the experiments, a model called Pooling BERT (refer to, for example, NPL 3) is used. In addition, the training data is recognizing textual entailment (RTE). FIGS. 4, 5, and 6 are diagrams showing the results of preliminary experiments.

The horizontal axis in FIG. 4 represents the number of iterations (number of steps) of the calculation process. Moreover, the vertical axis in FIG. 4 represents the accuracy of the model after training. The difference between the solid line and the dashed line is the random number seed provided during training. The dashed line corresponds to the random seed for cases in which training was successful (accuracy is improved). The solid line corresponds to the random seed for cases where training fails (accuracy is not improved).

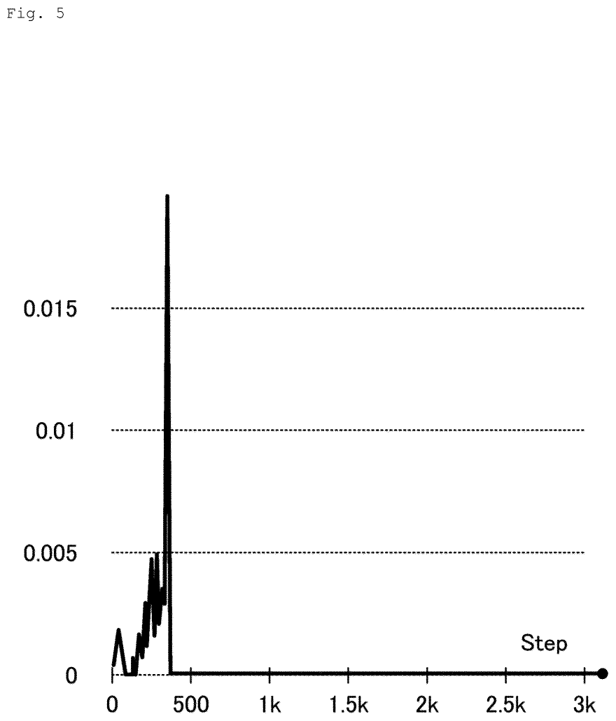

The horizontal axis in FIG. 5 represents the number of iterations (number of steps) of the calculation process. Moreover, the vertical axis in FIG. 4 represents the gradient of the loss in the normalization layer during training. The gradient of the loss is computed, for example, during the backpropagation procedure.

As shown in FIGS. 4 and 5, in the cases in which training fails, the gradient of the loss in the normalization layer disappears.

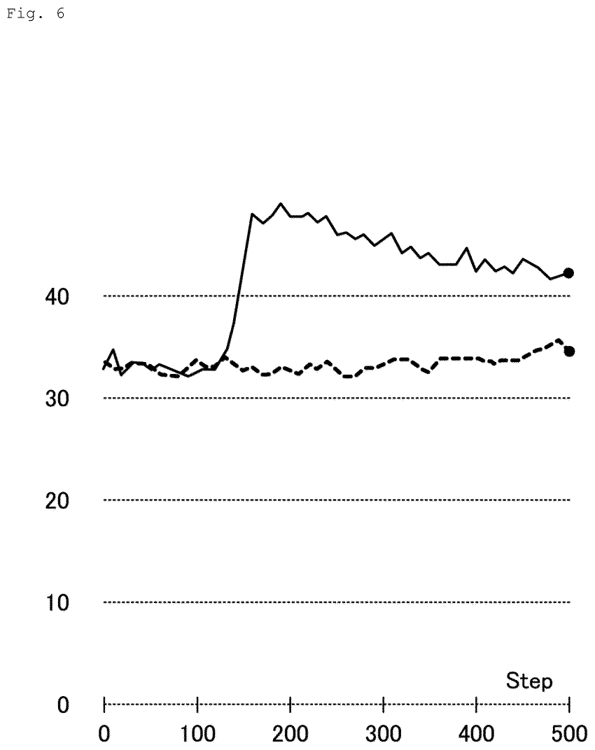

The vertical axis in FIG. 6 represents the number of iterations (number of steps) of the calculation process. Moreover, the vertical axis in FIG. 6 represents the magnitude of the norm of the vector input to the normalization layer during training. The dashed line corresponds to the random seed for the cases in which training is successful (accuracy is improved). The solid line corresponds to the random seed for the cases in which training fails (accuracy is not improved).

As shown in FIG. 6, in the cases in which training fails, the norm increases rapidly at the step in which the gradient disappears.

The results of preliminary experiments show that the theory of Expression (1) holds true.

$$[ Math . 1 ]$$

$$‖ \frac{\partial LN ( x )}{\partial x} ‖ = O ( \frac{\sqrt{d}}{‖ x ‖} ) \qquad ( 1 )$$

d is a dimension of a vector x input to a normalization layer. ∥·∥ is the norm of a vector. O is an order. Expression (1) shows that the derivative (gradient) of the normalization layer becomes smaller as the norm of the input vector becomes larger.

In addition, as proven in Lemma 3 of NPL 2, the derivative of the loss with respect to the input vector is always proportional to the x derivative of the normalization layer due to the chain rule of differentiation. Thus, the gradient disappears when the norm of x is large.

Referring to FIG. 1 again, the acquisition unit 151 acquires data necessary for fine-tuning from the correct answer information 142. For example, the acquisition unit 151 acquires a sequence of input vectors corresponding to a text in a natural language according to a task and a sequence of output vectors corresponding to information on a correct answer corresponding to the text.

The calculation part 152 sequentially inputs the sequence of input vectors acquired using the acquisition unit 151 to a pre-trained BERT constructed on the basis of the model information 141. Also, the calculation part 152 performs calculations using BERT including Transformer 21. The calculation part 152 uses a model using BERT to calculate an output for each of a plurality of input vectors.

The correction part 154 corrects the vectors so that the norms of the vectors input to the normalization layer included in the model are constant. The correction part 154 performs a correction process at the timing at which a vector is input to the normalization layer 21c and the normalization layer 21f of Transformer 21 during the calculation process using the calculation part 152. Furthermore, the correction process performed using the correction part 154 is called context normalization.

In addition, the correction part 154 corrects the vector so that the norm of the vector input to a normalization layer in which layer normalization is performed included in Transformer which constitutes the BERT becomes constant.

Here, it is assumed that the norm information 144 is initialized and the recorded norm is erased when the training process is started. For this reason, when a vector is input to any of the normalization layers for the first time in the training process, a norm is not recorded in the norm information 144.

In the correction process, first, the correction part 154 checks whether a norm is recorded in the norm information 144. When a norm is not recorded in the norm information 144, the norm of the vector input to the normalization layer is recorded in the norm information 144. In this case, the correction part 154 does not correct the norm.

On the other hand, when a norm is recorded in the norm information 144, the norm of the vector input to the normalization layer is corrected to the norm recorded in the norm information 144. In this case, the normalization layer receives vectors in which norms have been corrected.

In this way, the correction part 154 corrects the norm of a vector input to the normalization layer in a certain step so that the norm is equal to the norm of the vector input to the normalization layer in the previous step. For example, the correction process by the correction part 154 is described in pytorch as follows.

if self.scale is not None:

$$current\_scale = context\_layer . mean ( 0 ) . norm ( ) . detach ( )$$

$$context\_layer = ( context\_layer / current\_scale ) ⋆ self . scale$$

if self.training:

$$self . scale = context\_layer . mean ( 0 ) . norm ( ) . detach ( )$$

In this way, by referring to the norm information 144, the correction part 154 can correct the first vector so that the norm of the first vector input to the normalization layer included in the model is equal to the norm of the second vector last input to the normalization layer.

The updating part 155 updates the parameters of the model, that is, the model information 141, so that the sequence of vectors output from the model approaches the sequence of output vectors acquired using the acquisition unit 151. That is to say, the updating part 155 updates the model so that the output is optimized.

For example, the updating part 155 updates the parameters of the attention layer 21a and the FNN 21d of Transformer 21 through the backpropagation method. At this time, the updating part 155 calculates the derivatives of the losses of the normalization layer 21c and the normalization layer 21f.

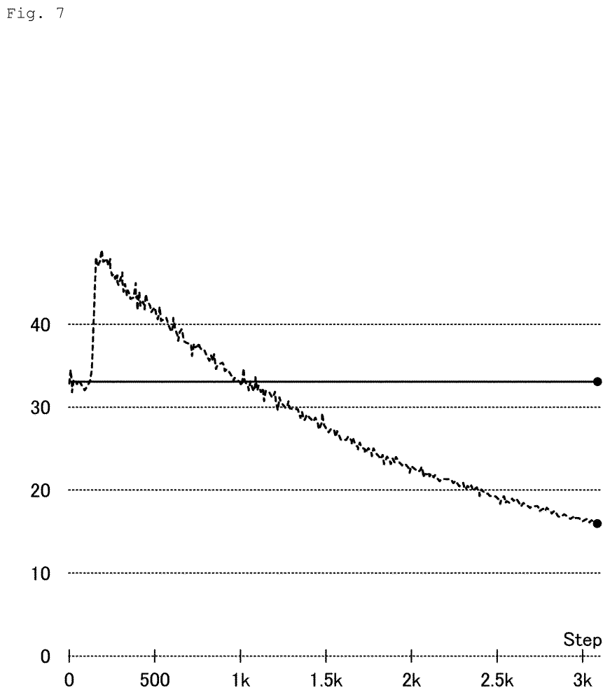

The effects of the first embodiment will be described. FIGS. 7, 8, and 9 are diagrams showing the effects of the first embodiment.

The vertical axis in FIG. 7 represents the number of iterations (number of steps) of the calculation process. Moreover, the vertical axis in FIG. 7 represents the magnitude of the norm of the vector input to the normalization layer during training. The dashed line corresponds to the case in which context normalization is not used (related art). The solid line corresponds to the case in which context normalization is used (first embodiment).

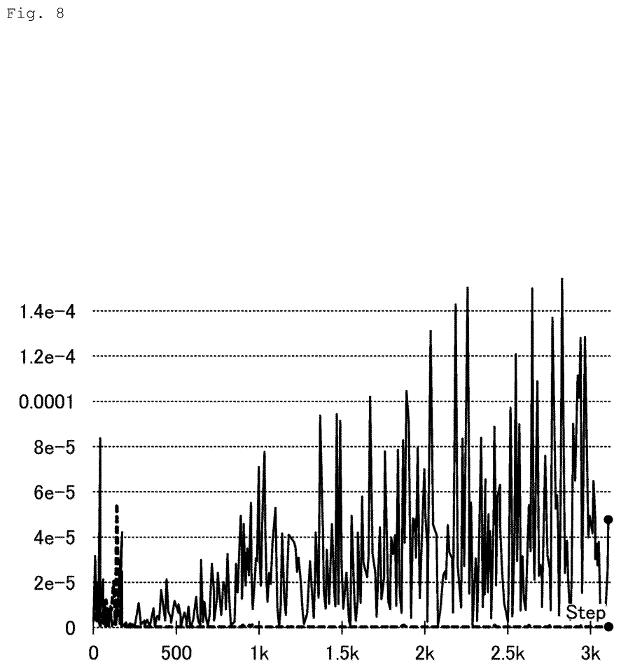

The horizontal axis in FIG. 8 represents the number of iterations (number of steps) of the calculation process. Moreover, the vertical axis in FIG. 8 represents the gradient of the loss in the normalization layer during training. The dashed line corresponds to the case in which context normalization is not used (related art). The solid line corresponds to the case in which context normalization is used (first embodiment).

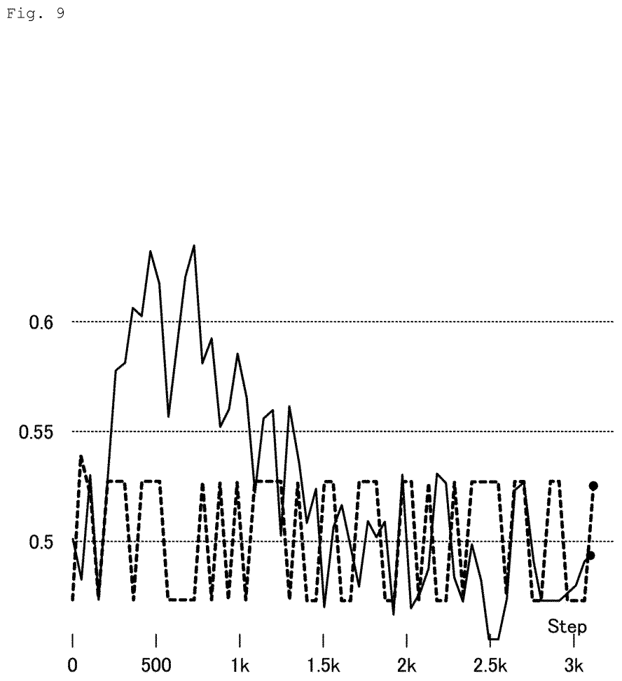

The horizontal axis in FIG. 9 represents the number of iterations (number of steps) of the calculation process. Moreover, the vertical axis in FIG. 9 represents the accuracy of the model after training. The difference between the solid line and the dashed line is the random number seed provided during training. The dashed line corresponds to the case in which context normalization is not used (related art). The solid line corresponds to the case in which context normalization is used (first embodiment).

As can be seen from FIG. 7, in the first embodiment, the magnitude of the norm of the vector input to the normalization layer is constant and stable. Moreover, as can be seen from FIG. 8, in the first embodiment, the disappearance of the gradient is prevented. Moreover, as can be seen from FIG. 9, in the first embodiment, the accuracy is improved. Note that, in the example of FIG. 9, the training result at the iteration number at which the accuracy is highest due to early stopping may be adopted. Thus, the first embodiment can obtain a trained model with higher accuracy than the technique in the related art.

### Processing in First Embodiment

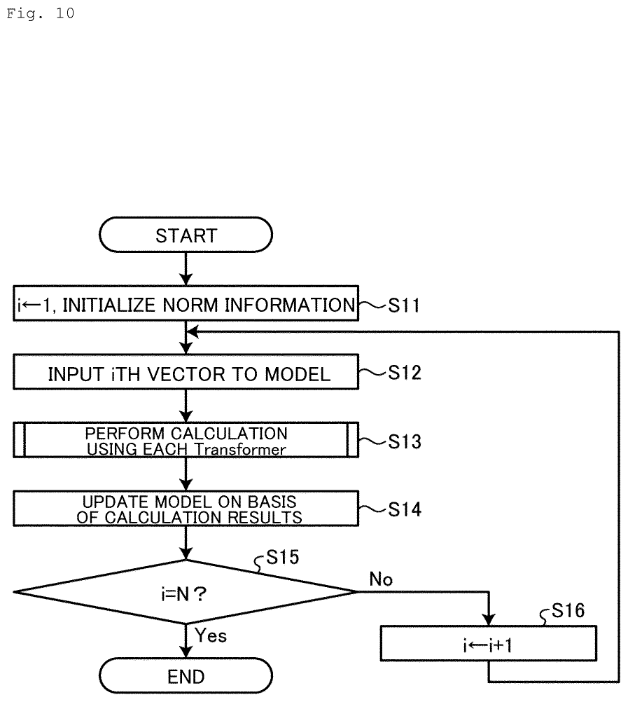

FIG. 10 is a flowchart for describing a flow of a fine-tuning process. The number of vector sequences in fine-tuning is set to N (where N is an integer equal to or greater than 1).

As shown in FIG. 10, first, the information processing device 10 assigns 1 to i to initialize the norm information 144 (Step S11). Note that the norm information 144 is initialized so that a norm has not been recorded. Also, the information processing device 10 inputs an ith vector among the N vectors to a model (BERT) (Step S12).

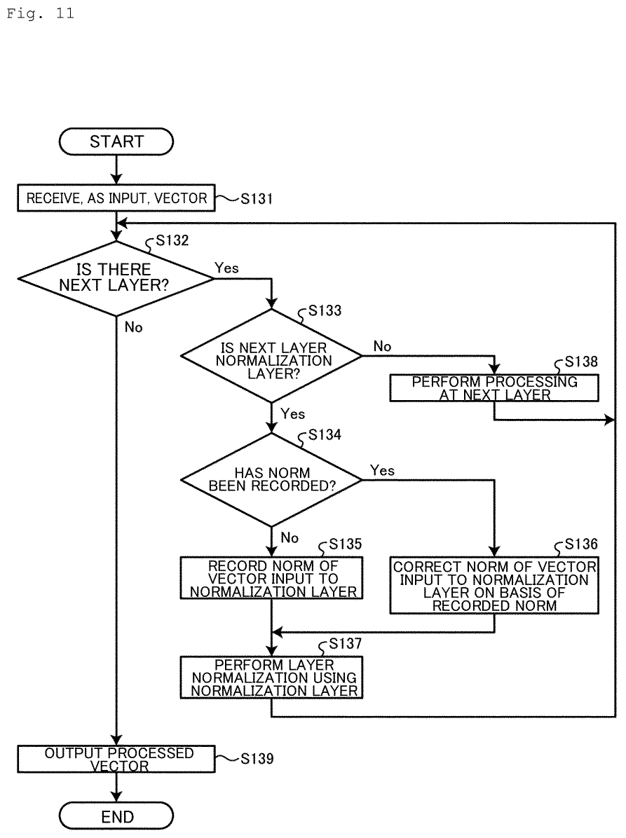

Here, the information processing device 10 performs calculations using each Transformer (Step S13). The details of Step S13 will be explained later with reference to FIG. 11.

Subsequently, the information processing device 10 updates the model on the basis of the calculation result, that is, the vector output from the model (Step S14).

Here, when i=N (Step S15, Yes) is satisfied, the information processing device 10 ends the process. On the other hand, when i=N is not satisfied (Step S15, No), the information processing device 10 increments i by 1 (Step S16) and returns to Step S12.

FIG. 11 is a flowchart for describing a processing flow by the Transformer. The process shown in FIG. 11 corresponds to Step S13 in FIG. 10.

As shown in FIG. 11, the information processing device 10 receives an input of a vector (Step S131). The information processing device 10 determines whether there is a next layer (Step S132).

For example, it is assumed that the processing order is set as follows: an attention layer 21a, an addition layer 21b, a normalization layer 21c, an FFN 21d, an addition layer 21e, and a normalization layer 21f. When there is a layer next in order from the layer for which processing has been completed, the information processing device 10 determines that there is a next layer.

For example, after the processing of the addition layer 21b is completed, the information processing device 10 determines that there is a next layer, the normalization layer 21c. Furthermore, for example, after the processing of the normalization layer 21f is completed, the information processing device 10 determines that there is no next layer.

When there is no next layer (Step S132, No), the information processing device 10 outputs the processed vector (Step S139). For example, the information processing device 10 outputs the output of the normalization layer f as a processed vector.

When there is a next layer (Step S132, Yes), the information processing device 10 determines whether the next layer is a normalization layer (the normalization layer 21c or the normalization layer 21f) (Step S133).

When the next layer is not the normalization layer (Step S133, No), the information processing device 10 performs processing in the next layer (Step S138). When the next layer is a normalization layer (Step S133, Yes), the information processing device 10 determines whether the norm has been recorded in the norm information 144 (Step S134).

When the norm has not been recorded (Step S134, No), the information processing device 10 records the norm of the vector input to the normalization layer (Step S135). Note that, after the norm information 144 is initialized in Step S11 of FIG. 10, the norm is in a state in which a norm has not been recorded. Also, in Step S135, the norm information 144 transitions to a state in which the norm is recorded.

When the norm has been recorded (Step S134, Yes), the information processing device 10 corrects the norm of the vector input to the normalization layer based on the recorded norm (Step S136). The information processing device 10 makes the norm of the vector input to the normalization layer equal to the recorded norm.

Also, the information processing device 10 performs layer normalization at the normalization layer. The norm of a vector subject to layer normalization is constant.

### Examples

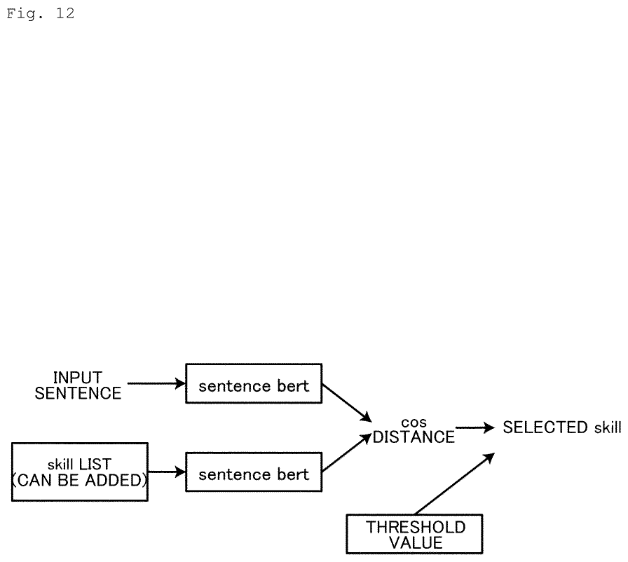

An example in which the first embodiment is applied to a business chat will be described with reference to FIG. 12. FIG. 12 is a diagram for explaining an example of application of the first embodiment to a business chat.

A business chat application (for example, slack) provided in the information processing device 10 acquires a first character string input by the user and a second character string indicating a skill. Subsequently, the application inputs the obtained first string (input sentence) and second string (skill list) into Sentence Bert (an example of BERT) which has been trained across languages and converts them into vectors.

Also, the application measures the distance between the vector representing the meaning of the character string and the vector representing the meaning of the skill by measuring the distance between the transformed vectors using cos distance. Subsequently, the application selects a skill on the basis of the measured distance. At this time, when the distance measured using the measurement part 123 is greater than the threshold value indicated by the threshold value information 143, the selection part 124 selects the general conversation.

Note that a skill is a series of processes including the execution of a specific program. On the other hand, a general conversation is a response to a user by outputting voice or the like.

The information addition phase and the operation phase performed by the information processing device 10 with respect to an application will be described below.

In the information addition phase, first, the information processing device 10 performs training for the entire language using Sentence Bert. The information processing device 10 may obtain a pre-trained Sentence Bert and store it as the model information 141.

Subsequently, the information processing device 10 performs fine-tuning through the method of the first embodiment using a small number of input sentences and the correct answer skill. Furthermore, the information processing device 10 determines a threshold value in which general conversations are included and the accuracy is the highest and stores it as threshold value information 143.

The operation phase will be explained. First, the information processing device 10 acquires text input to an application. For example, if the application is slack, the information processing device 10 acquires the text using slack's official api called bolt api.

Subsequently, the information processing device 10 passes the text to a fine-tuned Sentence Bert and converts it into a vector. Similarly, the information processing device 10 passes the skills to a fine-tuned Sentence Bert and converts them into vectors. The application selects and performs skills on the basis of the cos distance between vectors.

For example, the information processing device 10 acquires the text “Let's work!” input to an application, and enables the user to select skills for the start of work and to clock in to an in-house system.

### Effects of First Embodiment

As described above, the information processing device 10 includes the calculation part 152, the correction part 154, and the updating part 155. The calculation part 152 uses a model using BERT to calculate an output for each of a plurality of input vectors. The correction part 154 corrects the vectors so that the norms of the vectors input to the normalization layer included in the model are constant. The updating part 155 updates the model so that the output is optimized.

Furthermore, the correction part 154 corrects the vector so that the norm of the vector input to a normalization layer in which layer normalization included in the Transformer which constitutes the BERT is performed becomes constant.

Furthermore, the correction part 154 corrects the first vector so that the norm of the first vector input to a normalization layer included in the model is equal to the norm of the second vector last input to the normalization layer.

Thus, the norm of the vector input to the normalization layer is kept constant, which prevents the gradient of the loss of the normalization layer from disappearing. For this reason, according to the first embodiment, the accuracy of the model can be easily improved by fine-tuning. For example, according to the first embodiment, the accuracy of the model can be improved even if the search for hyperparameters is omitted.

### [System Configuration or Like]

Furthermore, each constituent element of each device shown in the drawings is merely a functional concept and does not necessarily have to be physically configured as shown in the drawings. That is to say, the specific form of distribution and integration of each device is not limited to that shown in the figure and all or a part of it can be functionally or physically distributed or integrated in any unit depending on various loads, usage conditions, or the like. Furthermore, each processing function performed using each device may be realized, in whole or in a part, by a central processing unit (CPU) and a program analyzed and executed by the CPU or may be realized as hardware using wired logic. Note that the program may be executed not only using a CPU but also by other processors such as a GPU.

Furthermore, of the various processes described in the embodiment, all or part of the processes described as being performed automatically can be performed manually or all or a part of the processes described as being performed manually can be performed automatically using known methods. In addition, the information including the processing procedures, control procedures, specific names, various data and parameters shown in the above documents and drawings can be changed arbitrarily unless otherwise specified.

### [Program]

As an embodiment, the information processing device 10 can be implemented by installing an adjustment program for performing the above-described adjustment process as package software or online software on a desired computer. For example, the information processing device can be made to function as the information processing device 10 by executing the above-mentioned adjustment program on the information processing device. The information processing device referred to herein includes desktop and notebook personal computers. Moreover, the information processing device also includes mobile communication terminals such as smartphones, mobile phones and personal handyphone systems (PHSs), as well as slate terminals such as personal digital assistants (PDAs).

Furthermore, the information processing device 10 can also be implemented as an adjustment server device which provides services relating to the above adjustment process to a client, the client being a terminal device used by the user. For example, the adjustment server device is implemented as a server device which provides an adjustment service which takes as input a small amount of learning data according to the task and outputs information on a fine-tuned model. In this case, the adjustment server device may be implemented as a Web server or may be implemented as a cloud in which services relating to the above adjustment processing are provided through outsourcing.

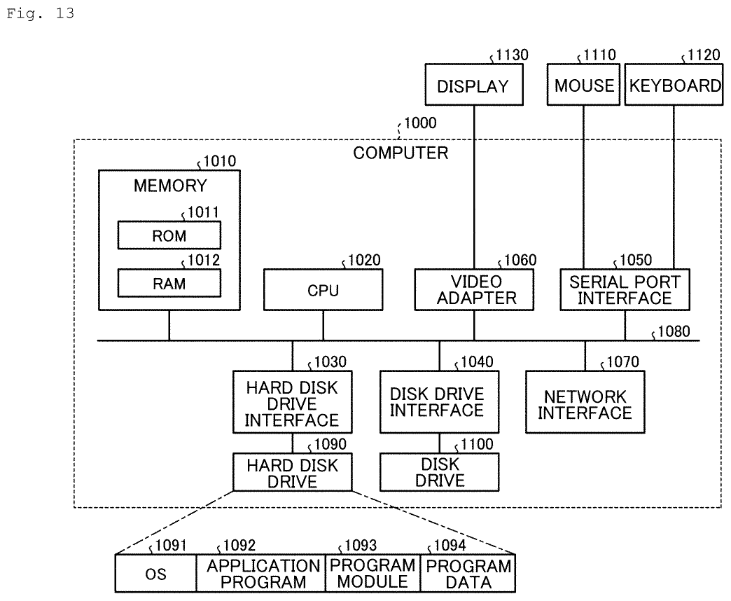

FIG. 13 is a diagram showing an example of a computer which executes an adjustment program. A computer 1000 includes, for example, a memory 1010 and a CPU 1020. Furthermore, the computer 1000 includes a hard disk drive interface 1030, a disk drive interface 1040, a serial port interface 1050, a video adapter 1060, and a network interface 1070. These parts are connected via a bus 1080.

The memory 1010 includes a read only memory (ROM) 1011 and a random access memory (RAM) 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is to say, the program that defines each process of the information processing device 10 is implemented as a program module 1093 in which computer-executable codes are written. The program module 1093 is stored on, for example, the hard disk drive 1090. For example, a program module 1093 for performing processes similar to those of the functional configuration of the information processing device 10 is stored in the hard disk drive 1090. Note that the hard disk drive 1090 may be replaced by a solid state drive (SSD).

Furthermore, setting data used in the processes of the above-described embodiments is stored as program data 1094 in, for example, the memory 1010 or the hard disk drive 1090. Also, the CPU 1020 reads out the program module 1093 and the program data 1094 stored in the memory 1010 and the hard disk drive 1090 into the RAM 1012 as necessary and performs the processes of the above-described embodiments.

Note that the program module 1093 and the program data 1094 are not limited to being stored in the hard disk drive 1090, but may also be stored in, for example, a removable storage medium and read by the CPU 1020 via a disk drive 1100 or the like. Alternatively, the program module 1093 and the program data 1094 may be stored in another computer connected via a network (such as a local area network (LAN) or a wide area network (WAN)). Also, the program module 1093 and the program data 1094 may be read by the CPU 1020 via the network interface 1070 from another computer.

### REFERENCE SIGNS LIST

10 Information processing device
11 Communication part
12 Input part
13 Output part
14 Storage part
15 Control part
141 Model information
142 Correct answer information
143 Threshold value information
144 Norm Information
151 Acquisition unit
152 Calculation part
154 Correction part
155 Updating part

1. An adjustment device, comprising:
calculation circuitry which calculates an output for each of a plurality of input vectors using a model using BERT;
correction circuitry which corrects a vector input to a normalization layer included in the model so that a norm of the vector is constant; and
updating circuitry which updates the model so that the output is optimized.

2. The adjustment device according to claim 1, wherein:
the correction circuitry corrects a vector so that a norm of the vector input to a normalization layer in which layer normalization is performed included in a Transformer constituting BERT is constant.

3. The adjustment device according to claim 1, wherein:
the correction circuitry corrects a first vector input to a normalization layer included in the model so that a norm of the first vector is equal to a norm of a second vector last input to the normalization layer.

4. An adjustment method, comprising:
calculating an output for each of a plurality of input vectors using a model using BERT;
correcting a vector input to a normalization layer included in the model so that the norm of the vector is constant; and
updating the model so that the output is optimized.

5. A non-transitory computer readable medium storing an adjustment program for causing a computer to execute processes of:
calculating an output for each of a plurality of input vectors using a model using BERT;
correcting a vector input to a normalization layer included in the model so that the norm of the vector is constant; and
updating the model so that the output is optimized.
